(19) United States
(12) Patent Application Publication
(10) Pub. No.: US 2023/0268798 A1
(43) Pub. Date: Aug. 24, 2023

(54) METHOD FOR THE PRODUCTION OF A BUSH

(71) Applicant: MAHLE International GmbH, Stuttgart (DE)

(72) Inventors: Patrick Altherr, Stuttgart (DE); Christoph Steinmetz, Ludwigsburg (DE)

(21) Appl. No.: 18/111,857

(22) Filed: Feb. 20, 2023

(30) Foreign Application Priority Data
Feb. 21, 2022 (DE) 10 2022 201 778.1

(51) Int. Cl. H02K 7/00

(52) U.S. Cl. CPC H02K 7/003

(57) ABSTRACT

A method for producing a bush and a bush for a rotor shaft are disclosed. The method includes: providing a flat metal strip; introducing at least one of (i) a surface structure onto one side of the flat metal strip for at least one of enlarging a heat-transferring area and directing a coolant, and (ii) at least one hole into the flat metal strip; and rolling up the flat metal strip to form the bush. The surface structure, if provided, lies on an inner surface area of the bush.

### CROSS-REFERENCE TO RELATED APPLICATION

This application claims priority to Germany Application No. DE 10 2022 201 778.1 filed Feb. 21, 2022, the contents of which are hereby incorporated by reference in its entirety.

### TECHNICAL FIELD

The present invention relates to a method for the production of a bush for arranging in a cavity of a rotor shaft. Furthermore, the invention relates to a bush produced according to this method and a rotor for an electric motor with a rotor shaft with a cavity in which such a bush is arranged. The invention relates furthermore to an electric motor with such a rotor.

### BACKGROUND

Through an increasing electrification, especially also with regard to electric vehicles, powerful electric motors are also used increasingly which are distinguished not only by a compact construction, but also by a high performance. A high performance density, however, also leads necessarily to high thermal loads and requires corresponding cooling concepts, for example an active cooling of a rotor of the electric motor used in such an electric vehicle. For this, for example, a cavity is provided in a rotor shaft of the rotor, through which cooling fluid, for example gas or liquid coolant, is directed and thereby cools the rotor shaft and rotor windings arranged thereon.

In order to be able to increase a cooling capacity here and thus indirectly also a performance of the electric motor, internal surface areas of the cavity can be provided here with a surface structure for enlarging the surface which is available for heat transfer. This processing of the inner wall of the cavity is, however, only possible in a comparatively laborious and hence expensive manner.

The present invention is therefore concerned with the problem of indicating a method by means of which the disadvantages which are present in known rotor shafts can be at least minimized.

This problem is solved according to the invention by the subject of the independent claim(s). Advantageous embodiments are the subject of the dependent claims.

### SUMMARY

The present invention is based on the general idea of no longer enlarging an inner surface, available for heat transfer, in a hollow rotor shaft in that an inner surface of the hollow rotor shaft is provided with this surface structure, but rather firstly a separate bush is produced with such a surface structure, which is subsequently inserted into a cavity of a hollow rotor shaft, whereby the laborious processing of the inner surface area of the hollow rotor shaft can be dispensed with. In the method according to the invention for the production of a bush for inserting into a cavity of a rotor shaft, firstly a flat metal strip is produced, in particular cut to size or stamped. A production takes place here such that this metal strip can be inserted, in a later rolled up state, into the cavity of the rotor shaft and arranged therein. On one side of the flat metal strip a surface structure is now introduced for enlarging a surface available for heat transfer and/or for directing a coolant, wherein additionally or alternatively also a hole can be introduced into the flat metal strip. Such a hole also constitutes a surface structure which enlarges the surface available for heat transfer and thus improves the heat transfer. Subsequently, the flat metal strip is rolled up to form the bush, wherein the surface structure which is present if applicable now lies on an inner surface area of this bush. When exclusively holes are present, basically it does not matter how the rolling up of the metal strip takes place to form the bush. The method according to the invention offers the great advantage here of being able to already introduce the depressions or respectively generally the surface structure or the holes in the flat, non rolled-up state into the sheet or respectively the metal strip, which is not only comparatively easy, but also distinctly more economical than a processing of the inner surface area of a cavity of a rotor shaft. A larger cooling surface can be produced with the surface structure or respectively the holes, and in addition a flow can be braked, wherein the surface structure serves additionally for an eddying of the coolant flowing in the bush, whereby a uniform cooling and an improved heat transfer are possible. The material thickness of the metal strip here is preferably less than 5 mm. It is thus possible with the bush according to the invention to introduce more easily and more economically the surface structure improving the cooling and thereby to produce the entire rotor shaft or respectively the entire rotor more economically.

In a further advantageous embodiment of the method according to the invention, an outer surface area of the bush is post-processed, in particular ground. Hereby, necessary shape- and position tolerances and a necessary dimensional accuracy can be achieved.

Expediently, the surface structure is introduced by embossing, lasering, water-jetting, milling, a machining method, rolling or bending. Additionally or alternatively, also at least one hole can be introduced into the metal strip for example by drilling or stamping. Purely theoretically, of course in addition further methods, in particular chemical methods, such as etching, are also conceivable. This non-conclusive list already suggests what varied production possibilities are conceivable for the production of the holes or respectively of the surface structure. All the named method variants have in common here that these are extremely precise, economical and proven industrially over many years.

After the producing of the bush according to the method described in the previously mentioned paragraphs, it is inserted into the cavity of the rotor shaft and fixed therein, for example jammed, soldered or otherwise fixed.

The present invention is further based on the general idea of indicating a bush which is produced according to the method in accordance with the preceding paragraphs. With such a bush, in particular surface structures increasing a cooling capacity can be introduced economically and with high quality firstly on an even or respectively flat metal strip, which is only rolled up to form the bush in a later working step and is subsequently inserted into the cavity of the rotor shaft.

In an advantageous further development of the bush according to the invention, the surface structure has peaks and troughs, wherein a height difference H between one of the peaks and one of the troughs is 0.20 mm≤H≤4.0 mm. Through such a height difference, the surface of the bush can be distinctly enlarged, whereby also the surface available for the transferring of heat can also be distinctly enlarged and hence the heat transfer and a cooling can be improved. Here, the peaks or respectively troughs or generally the surface structure can have sharp-edged grooves or respectively pinnacles, but also rounded peaks and troughs.

In a further advantageous embodiment of the bush according to the invention, the at least one hole has a circular, an oval or an angled, in particular a rectangular or triangular, shape. This non-conclusive list already suggests what varied possibilities the shape of the holes can take. It is important here only that in the region of the hole a direct access can take place of a coolant, flowing in a cavity, to an inner surface area of the rotor shaft, whereby a particularly effective heat transfer is possible. Through the bush and the edging of the hole, formed by the bush, nevertheless the surface available for the heat transfer can be enlarged and thereby, likewise, the cooling capacity can be improved.

Expediently, the surface structure has a thread. Such a thread can be formed either with or without a pitch and thereby contribute for example to a conveying of the coolant in the bush or respectively in the rotor shaft. A cross-sectional shape of a winding should preferably be intensively rounded here and not embodied as a triangle. A pitch of such a thread can be between 0.5 mm and 4 mm, wherein in the case of multi-threaded windings also a multiple thereof can be provided. A thread without pitch, i.e. only rings, also increase a heat transfer between the sheet packages arranged on the rotor shaft and the coolant flowing in the cavity, whereby the performance of an electric motor equipped with such a rotor shaft can be increased.

Owing to the production of the bush on the basis of a sheet- or respectively metal strip, the possibility additionally presents itself to embody the thread-like profile from a middle region of the bush with oppositely directed pitches, so that a transport of the cooling medium in two different directions towards the respective shaft ends is made possible.

In a further advantageous embodiment of the bush according to the invention, the latter is formed in a slitted manner, for example it has a slit with a width B between 0.05 mm and 1.0 mm. Such a slit offers the great advantage that the mounting of the bush in the cavity of the rotor shaft can take place comparatively easily, as the bush, for mounting, only has to be inserted in a compressed manner into the cavity of the rotor shaft, whereupon then, after a releasing, it is then prestressed elastically outwards against the inner surface area of the cavity in the rotor shaft. This slit can be embodied in the form of a straight fitting joint, an oblique fitting joint and also a V-shaped fitting joint. Here, solely this pre-stressing can be sufficient for the fixing of the bush in the cavity of the rotor shaft, so that a further, in particular separate, fixing does not have to take place. Hereby, a particularly easy mounting of the bush of the rotor shaft can take place.

In a further advantageous embodiment of the bush according to the invention, two circumferential ends of the bush are connected to one another via a form-fitting connection. Such a form-fitting connection can be for example a puzzle piece connection or generally a male-female connection. Especially puzzle piece connections which constitute an undercut connection, bring about a connection of the two circumferential ends of the bush which is able to be loaded under tractive force. A male/female connection, on the other hand, can further permit a springing back of the rolled-up bush.

In a further advantageous embodiment of the bush according to the invention, the latter is formed in one piece. This offers the great advantage that the bush can be produced comparatively easily and, in addition, is able to be handled easily.

In a further advantageous embodiment of the bush according to the invention, the latter is formed in a multi-layered manner and has an, in particular, outer layer of zinc, aluminium or a tin alloy and/or an, in particular, inner layer of copper or of a copper- or aluminium alloy. A carrier material of the bush can be made here of steel, aluminium or an aluminium alloy. An aluminium layer has excellent sliding characteristics here, whereby an inserting of the bush into the cavity of the rotor shaft is facilitated. Copper or respectively copper alloys, on the other hand, have a particularly high thermal conductivity, whereby a high heat transfer and hence an improved cooling capacity can be achieved.

The present invention is further based on the general idea of providing a rotor for an electric motor with a rotor shaft with a cavity, in which a bush described in the previous paragraphs is arranged. Hereby, the advantages named with respect to the producibility and the production costs can also be transferred to the rotor.

The present invention is further based on the general idea of equipping an electric motor with a rotor described in the previous paragraph. Hereby, an electric motor can be created which is able to be produced economically which, at the same time, is well able to be cooled and thereby can be operated with a high performance.

Further important features and advantages of the invention will emerge from the subclaims, from the drawings and from the associated figure description with the aid of the drawings.

It shall be understood that the features mentioned above and to be explained further below are able to be used not only in the respectively indicated combination, but also in other combinations or in isolation, without departing from the scope of the present invention.

Preferred example embodiments of the invention are illustrated in the drawings and are explained more closely in the following description.

### BRIEF DESCRIPTION OF THE DRAWINGS

There are shown here, respectively schematically:

FIG. 1 a sectional illustration through an electric motor according to the invention, with a rotor with a rotor shaft, in the cavity of which a bush, produced by a method according to the invention and likewise according to the invention, is arranged,

FIG. 2 a detail illustration from FIG. 1,

FIG. 3 a view onto a bush according to the invention,

FIG. 4 a detail illustration of a possible embodiment of a bush according to the invention, with an undercut connection,

FIG. 5 an embodiment of a slitted bush according to the invention, with holes.

### DETAILED DESCRIPTION

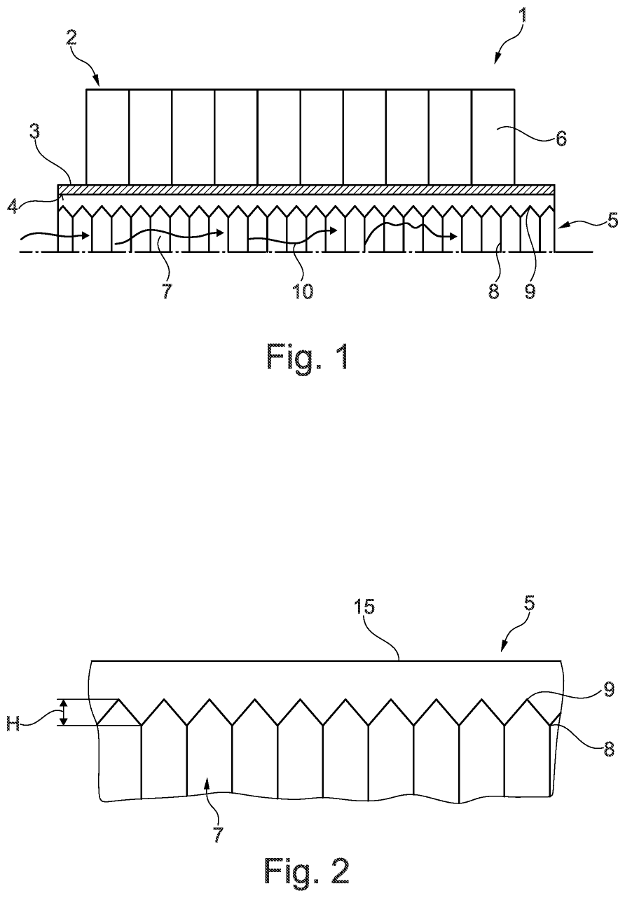

According to FIG. 1, an electric motor 1 according to the invention, which can be installed for example in a motor vehicle which is at least partially electrically driven, has a rotor 2 with a rotor shaft 3 and a cavity 4, wherein a bush 5 according to the invention is arranged, in particular plugged in or jammed in, in the cavity 4. Sheet packages 6 are arranged on the rotor shaft 3.

In order to now be able to achieve as high a performance of the electric motor 1 as possible, its rotor 2 is internally cooled, i.e. a coolant 10 flows through the cavity 4, in the present case through the bush 5. For the further increase of performance of the electric motor 1, the bush 5 has on an inner surface area a surface structure 7 with peaks 8 and troughs 9. Through the surface structure 7, a coolant 10 flowing in the bush 5 in operation, is eddied and thereby homogenised, whereby an improved cooling effect can be achieved. Furthermore, the surface structure 7 brings about an enlargement of the surface which is available for the heat transfer, and thereby improves the cooling capacity.

A height difference H (cf. FIG. 2) between one of the peaks 8 and one of the troughs 9 can be between 0.2 mm and 4.0 mm here, wherein of course the peak tops or respectively troughs can be configured to be pointed or rounded or also plateau-shaped. Purely theoretically of course also not only are uniform peaks 8 or respectively troughs 9 provided, but also distributed as desired.

Observing the surface structure 7 in the case of the bush 5 according to FIGS. 1 and 2, it can be seen that the surface structure 7 forms a thread there. A pitch of such a thread can be between 0.4 mm and 4 mm, whereby depending on the pitch of the thread a faster or slower conveying of the coolant 10 takes place through the bush 5. Purely theoretically, however, the pitch of the thread can also be zero, whereby a longer dwelling of the coolant 10 in the bush 5 can be achieved.

Additionally or alternatively to the surface structure 7, the bush 5 can also have holes 11, as is illustrated according to FIG. 5, wherein the holes 11 completely penetrate the bush 5. Alternatively again such holes can also be formed with a thin base, i.e. only as a depression. Irrespective of the embodiment, such depressions or respectively holes 11 present an enlargement of the surface which is available for heat transfer and thereby enable an improved cooling performance.

Observing the bush 5 of FIG. 5 further, it can be seen that it has a slit 12 which in particular simplifies an introducing and fixing of the bush 5 in the cavity 4 of the rotor shaft 3, as for the mounting of the bush 5 in the cavity 4, it only has to be slightly compressed and can then be inserted into the cavity 4. When the bush 5 is then released, it tensions elastically against the inner surface area of the cavity 4 autonomously, whereby for example a further fixing can be omitted. A width B of the slit 12 occurring in the inserted state of the bush 5 between the ends lying opposite one another in diameter is defined from the ratio of the difference of the diameters “bush 5 untensioned to shaft inside diameter” relative to the width B of the slit 12 of the bush 5 occurring in the inserted state under specification of a ratio value of 0.318±0.01. Depending on the shaft inside diameter, a small width B of the slit 12 denotes an only very small reduction of the bush diameter and consequently an extremely small joint gap. Depending on the outside diameter of the bush 5 in the untensioned state, a larger width B of the slit 12 is required, in order to be able to join the bush 5 at all. The following applies here:

A bush diameter +0.1 mm with respect to the shaft inside diameter of 30-50 mm entails ca. 0.35 mm width B of the slit 12, whereas a bush diameter +0.2 mm with respect to the shaft inside diameter of 30-50 mm requires ca. 0.65 mm width B of the slit 12. With a bush diameter +0.3 mm with respect to the shaft inside diameter of 30-50 mm, this requires ca. 0.95 mm width B of the slit 12. A relationship results herefrom.

$$\frac{( outside ∅ of the bush 5 untensioned - shaft inside ∅ )}{width B of the slit 12} \leq 0.318 \pm 0.01$$

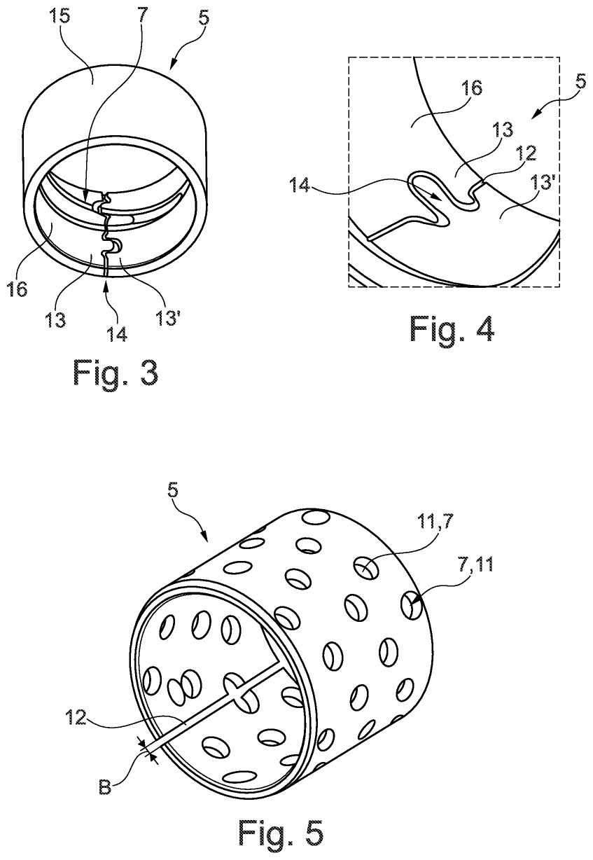

In the bushes 5 illustrated according to FIGS. 3 and 4, it can be seen that two circumferential ends 13, 13′ are connected to one another via a form-fitting connection 14. According to FIG. 3, the form-fitting connection 14 is configured here as a so-called male/female connection, whereas according to FIG. 4 this is configured in the manner of a puzzle connection and can form for example an undercut connection. Hereby it is possible to fix the two circumferential ends 13, 13′ of the bush 5 according to the invention securely to one another and for example to close a slit 12 lying therebetween.

The bush 5 can be formed here in one piece, wherein purely theoretically it is also conceivable that this is formed in a multi-layered manner, so that the bush 5 has at least one, in particular outer, layer 15 of zinc, aluminium or a tin alloy and/or an, in particular inner, layer 16 of for example copper or brass or aluminium. The base material of the bush 5 is usually formed from steel and the layers 15, 16 are thinner than the base material. In order to be able to achieve as high a heat transfer as possible to the coolant 10 flowing in the bush 5, it is advantageous to form the inner layer 16 of the bush 5 from a material with good thermal conductivity, i.e. for example copper or brass. A forming of the outer layer 15 from zinc or respectively aluminium or from a tin alloy offers the advantage furthermore that hereby good sliding characteristics are to be achieved, whereby an inserting of the bush 5 into the cavity 4 of the rotor shaft 3 is simplified. Of course, a completely one-piece configuration of the bush 5 and also a single-layer configuration of the bush 5 is also conceivable, for example from copper, as is illustrated according to FIG. 5.

In order to now be able to produce the rotor 2 as economically as possible, a method according to the invention is proposed, in which firstly the bush 5 is prefabricated separately and is only subsequently inserted into the cavity 4 of the rotor shaft 3. Hereby, a laborious processing of an internal surface area of the cavity 4, taking place from the interior, can be dispensed with. The bush 5 according to the invention is produced here in accordance with the method according to the invention as follows:

Firstly, a flat metal strip is produced, in particular cut to size or stamped, wherein subsequently on one side of the flat metal strip the surface structure 7 is introduced for enlarging the heat-transferring area and/or for directing the coolant 10. Additionally or alternatively, further also at least one hole 11 can be introduced into the flat metal strip. Subsequently, this flat metal strip is rolled up to form the bush 5, wherein the surface structure 7, which is present if applicable, lies on an inner surface area (cf. FIGS. 1 and 2).

The outer surface area of the bush 5 can be subsequently further post-processed, for example ground, in order to balance out dimension- and position tolerances. The surface structure 7 can be introduced for example by embossing, lasering, water-jetting, milling, grinding, a machining method, rolling or bending. The at least one hole 11 can be introduced for example by stamping or drilling. Of course, it is also conceivable here that the surface structure 7 is provided cumulatively with at least one hole 11, or that the hole 11 forms a component part of the surface structure 7.

Through the separation of the production of the surface structure 7 from the actual producing of the rotor 2, the surface structure 7 can be produced extremely economically and nevertheless in a high-quality manner. Surface structures 7 can also be created which would not be able to be thus produced with a processing of an inner surface area of the cavity 4 of the rotor shaft 3.

With the method according to the invention for the production of the bush 5 and for the production of the rotor 2, thus also an electric motor 1 can be produced with such a rotor 2 more economically, but nevertheless having high performance.

1. A method for producing a bush for arranging in a cavity of a rotor shaft, comprising
providing a flat metal strip,
introducing at least one of (i) a surface structure onto one side of the flat metal strip for at least one of enlarging a heat-transferring area and directing a coolant, and (ii) at least one hole into the flat metal strip,
rolling up the flat metal strip to form the bush, wherein the surface structure if provided lies on an inner surface area of the bush.

2. The method according to claim 1, further comprising post-processing an outer surface area of the bush.

3. The method according to claim 1, wherein at least one of:
the surface structure is introduced by embossing, lasering, water-jetting, milling, a machining method, rolling or bending, and
the at least one hole is introduced by stamping or drilling.

4. A bush for a rotor shaft, comprising:
a flat metal strip rolled up to provide a circumferentially extending inner surface area and a circumferentially extending outer surface area;
at least one of (i) a surface structure provided on the inner surface area for at least one of enlarging a heat-transferring area and directing a coolant, and (ii) at least one hole penetrating through the flat metal strip.

5. The bush according to claim 4, wherein the surface structure has peaks and troughs, wherein a height difference H between a peak and a trough is 0.20 mm≤H≤4.0 mm.

6. The bush according to claim 4, wherein the at least one hole has a circular, oval or angled shape.

7. The bush according to claim 4, wherein the surface structure defines a thread.

8. The bush according to claim 4, wherein the flat metal strip is slitted, wherein a slit has a ratio of a difference of a bush outside diameter in untensioned state to a shaft inside diameter relative to a width of the occurring slit in an inserted state of ≤0.318±0.01.

9. The bush according to claim 4, wherein two circumferential ends of the flat metal strip are connected to one another via a form-fitting connection.

10. The bush according to claim 4, wherein the flat metal strip is formed in one piece.

11. The bush according to claim 4, wherein the flat metal strip has at least one layer of zinc, aluminium or a tin alloy or a layer of copper or a copper alloy or an aluminium alloy.

12. The bush according to claim 4, wherein the flat metal strip is composed of a carrier material of steel, aluminium or an aluminium alloy.

13. A rotor for an electric motor, comprising:
a rotor shaft with a cavity,
a bush arranged in the cavity, the bush including:
a flat metal strip rolled up to provide a circumferentially extending inner surface area and a circumferentially extending outer surface area;
at least one of (i) a surface structure provided on the inner surface area for at least one of enlarging a heat-transferring area and directing a coolant, and (ii) at least one hole penetrating through the flat metal strip.

14. An electric motor comprising the rotor according to claim 13.

15. The rotor according to claim 13, wherein the surface structure is provided, the surface structure including peaks and troughs, and wherein a heat difference H between a peak and a trough is 0.20 mm≤H≤4.0 mm.

16. The rotor according to claim 13, wherein the at least one hole is provided, the at least one hole having a circular, oval, or angled shape.

17. The rotor according to claim 13, wherein the bush is slitted, wherein a slit has a ratio of a difference of a bush outside diameter in untensioned state to a shaft inside diameter relative to a width of the occurring slit in an inserted state of ≤0.318±0.01.

18. The rotor according to claim 13, wherein two circumferential ends of the bush are connected to one another via a form-fitted connection.

19. The rotor according to claim 13, wherein the bush has a layer of copper, copper alloy, or aluminium alloy disposed on the inner surface area.

20. The rotor according to claim 13, wherein the bush has at least one layer of zinc, aluminium, or a tin alloy disposed on an outer surface area.
